(19) United States
(12) Patent Application Publication
(10) Pub. No.: US 2024/0001945 A1
(43) Pub. Date: Jan. 4, 2024

(54) METHOD AND SYSTEM FOR CALIBRATING AN ADAS/ADS SYSTEM OF VEHICLES IN A VEHICLE POOL

(71) Applicant: Dr. Ing. h.c. F. Porsche Aktiengesellschaft, Stuttgart (DE)

(72) Inventor: Moritz Markofsky, Renningen (DE)

(21) Appl. No.: 18/205,773

(22) Filed: Jun. 5, 2023

(30) Foreign Application Priority Data
Jul. 4, 2022 (DE) 10 2022 116 562.0

(51) Int. Cl. B60W 50/04; G01M 17/00

(52) U.S. Cl. CPC B60W 50/04; G01M 17/00; B60W 2050/0083

(57) ABSTRACT

A method is provided for validation and/or calibration of an advanced driver assistance system (ADAS) and/or an automated driving system (ADS) in which the ADAS/ADS can be executed in both a virtual environment and a real-world environment for a vehicle pool that has multiple vehicles. The method includes: inputting a vehicle model that is described by vehicle parameters; inputting test scenarios for which the ADAS/ADS is tested in the virtual environment (141) with the vehicle (143); inputting evaluation criteria (133) with which a performance (151) of the ADAS/ADS is evaluated in a test drive (102); virtual test driving for all vehicles of the vehicle pool; evaluating (111) all results to identify the vehicle having the worst result; selecting the real vehicle corresponding to the worst-case vehicle; and validating the ADAS/ADS by at least one real test drive with this vehicle.

### CROSS REFERENCE TO RELATED APPLICATION

This application claims priority on German Patent Application No 10 2022 116 562.0 filed Jul. 4, 2022, the entire disclosure of which is incorporated herein by reference.

### BACKGROUND

### Field of the Invention

The invention relates to a method, a system, and a computer program product for validating and/or calibrating an advanced driver assistance system (ADAS) and/or an automated driving system (ADS).

### Related Art

An advanced driver assistance system (ADAS) and/or an automated driving system (ADS) must be tested, validated, adjusted and or calibrated for vehicles in road traffic or prototype vehicles on test terrains. These tests should assess critical properties for all vehicle derivatives of a series of vehicles that share some common properties. Test results are to be considered for ADAS/ADS validation in vehicles of this series, or should demonstrate at least most of the difficulties that may arise in this vehicle series.

U.S. Pat. No. 11,507,717 B2 discloses a method for simulating traffic for an environment where vehicles can drive automatically. A method for determining identifiers for the environment to be automatically driven with vehicles also is discussed.

EP 3 621 052 A1 describes a method for analyzing the driving behavior of motor vehicles. The method captures the contours and the trajectory of a motor vehicle. These captured data are used to create a vehicle model for later simulation of the motor vehicle in a simulation environment.

US 2019/0235521 A1 discloses a scenario-based method for validating an autonomous driving operation of a motor vehicle. The method uses synthetic data sets obtained in a virtual environment in addition to real sensor data sets.

In light of this background, an object of the invention is to provide a method for identifying a vehicle that is particularly suitable for ADAS/ADS validation and with the identified vehicle combining all or at least most of the properties of vehicles of a vehicle pool critical to the ADAS/ADS validation. The vehicle pool comprises a basic model of a series and all possible derivatives with respective equipment options. A further object is to provide a system on which the method can be carried out.

### SUMMARY OF THE INVENTION

The invention generally relates to a method for validation and/or calibration of an advanced driver assistance system (ADAS) and/or an automated driving system (ADS) so that the ADAS/ADS can be executed in both a virtual environment and a real environment. The vehicle pool comprises multiple real vehicles, and each real vehicle of the vehicle pool can be mapped onto the virtual environment by means of vehicle or scenario parameters.

One aspect of the method includes: inputting a vehicle model that is described by vehicle parameters, such as engine size or brake specifications; inputting test scenarios, such as braking distance or rate of deceleration for which the ADAS/ADS is tested in a virtual environment with the respective vehicle; and inputting evaluation criteria with which a performance of the ADAS/ADS is evaluated in a virtual and/or real test drive. The method proceeds by virtual test driving for all vehicles of the vehicle pool, with results of the evaluation criteria being recorded for each test drive. The method continues by evaluating all of the results and identifying the vehicle with the worst results as the worst-case vehicle, as determined by the virtual test drives. The method then includes selecting the real vehicle from the vehicle pool corresponding to the worst-case vehicle. The ADAS/ADS then is validated by at least one real test drive with this selected real vehicle and the ADAS/ADS of all vehicles are calibrated or adjusted, if required, based on the evaluation of the worst-case vehicle.

The method of the invention provides the so-called worst-case vehicle for a whole series, but advantageously avoids having to test all vehicles of the series to gain knowledge, for example concerning improvements and/or calibration in the ADAS/ADS to be validated. Thus, the method significantly reduces test effort and makes the validation process much more efficient for a particular ADAS/ADS version.

It is conceivable that, through additional virtual and/or real test drives with other vehicles of the vehicle pool, it can be demonstrated that all or at least most of the properties of the vehicles of the vehicle pool influencing the performance of the ADAS/ADS are demonstrated by the worst-case vehicle.

The performance of the ADAS/ADS is given, for example, by a grade in the performance of a driving task, for example, a minimum distance from a vehicle driving ahead, within which the ADAS/ADS can bring the ADAS/ADS controlled vehicle to a standstill. Another example is a maximum value of (negative) acceleration occurring in a deceleration scenario. The lower this value is, the higher the ride comfort perceived by vehicle occupants, and thus the better the performance of the ADAS/ADS.

In one embodiment, a transferability of the evaluation results for the performance of the ADAS/ADS on the worst-case vehicle to all other vehicles of the vehicle pool is checked by additional virtual test drives after the calibration or adjustment. This can be checked by additional virtual test drives and can demonstrate that the evaluation results achieved with the worst-case vehicle, as determined according to the invention, stand in or apply for the entire vehicle pool. It is conceivable to carry out a so-called proof-of-principle by performing one-time real test drives with at least one additional vehicle of the vehicle pool to demonstrate the transferability of the results achieved in the worst-case vehicle to the vehicle pool and to validate further ADAS/ADS versions only with the worst-case vehicle according to the invention.

In a further embodiment, the vehicle parameters describing a vehicle model are assigned to different vehicle derivatives and/or variants of equipment. Examples include differentiated motorization, specification of the brakes, for example ceramic braking, or a built-in radar for an automated spacer.

In another embodiment of the method, at least one scenario for testing the ADAS/ADS in the virtual environment is emergency braking at the end of a traffic jam as a function of different initial speeds.

In yet another embodiment, the at least one evaluation criterion is selected from: duration until standstill upon full braking, and minimum duration until impact.

The invention also relates to a system for validating and/or calibrating an advanced driver assistance system (ADAS) and/or an automated driving system (ADS) of vehicles in a vehicle pool. The ADAS/ADS can be executed in both a virtual environment and a real-world environment. The vehicle pool comprises multiple real vehicles, and each real vehicle of the vehicle pool can be mapped onto the virtual environment by scenario parameters or vehicle parameters. The system is configured to carry out the steps of: inputting a vehicle model that is described by the vehicle parameters; inputting test scenarios for which the ADAS/ADS is tested in the virtual environment with the respective vehicle; inputting evaluation criteria with which a performance of the ADAS/ADS is evaluated in a virtual and/or real test drive; virtual test driving all vehicles of the vehicle pool, with results of the evaluation criteria being recorded for the virtual test drive; evaluating all results to identify the worst-case vehicle as the vehicle having the worst result; and selecting the real vehicle from the vehicle pool corresponding to the worst-case vehicle, wherein the ADAS/ADS is validated by at least one real test drive with this vehicle.

In some embodiments, the system is configured to check a transferability of the evaluation results for the performance of the ADAS/ADS on the worst-case vehicle to all other vehicles of the vehicle pool by additional virtual test drives.

In a further configuration of the system, the vehicle parameters that describe a vehicle model are associated with different vehicle derivatives and/or configuration variants.

In yet another configuration of the system, at least one scenario for testing the ADAS/ADS in the virtual environment comprises emergency braking at the end of a traffic jam as a function of different initial speeds.

In yet another configuration of the system, at least one evaluation criterion is selected from duration until standstill upon full braking and minimum duration until impact.

A computer program product also is proposed and has a computer-readable medium that stores a program code that can be executed for validation and/or calibration of an advanced driver assistance system (ADAS) and/or an automated driving system (ADS). The ADAS/ADS can be executed in both a virtual environment as well as in a real environment. A vehicle pool comprises multiple real vehicles, and each real vehicle of the vehicle pool can be mapped onto the virtual environment by vehicle parameters. When executed on a computing unit, the program code prompts the computing unit to carry out the steps of the method described above.

Additional advantages and configurations of the invention result from the description and the enclosed drawing.

It is understood that the aforementioned features and the features yet to be explained in the following can be used in the specified combination, and in other combinations or on their own, without departing from the scope of the invention.

### BRIEF DESCRIPTION OF THE DRAWINGS

FIG. 1 Is a block diagram of a configuration of a system according to the invention.

### DETAILED DESCRIPTION

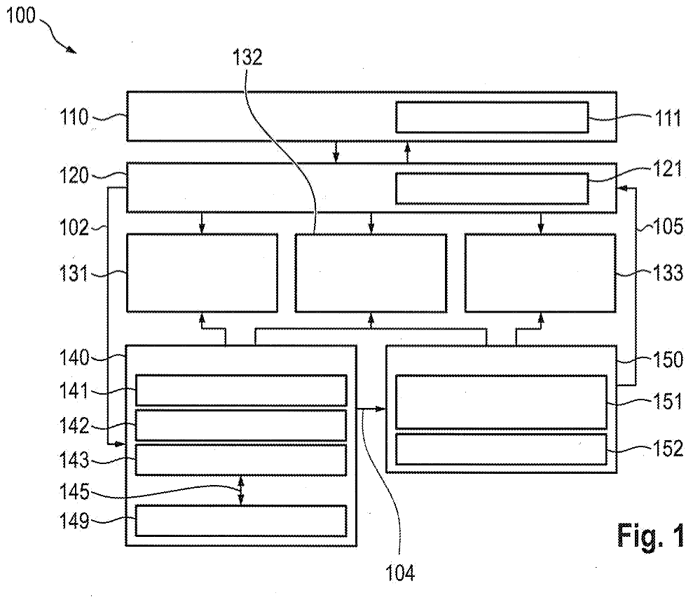

FIG. 1 is a block diagram 100 of a configuration of the system according to the invention. The block diagram 100 illustrates a workflow structure for a scenario-based or vehicle-based simulation environment with which an ADAS/ADS is validated. For this purpose, a test agent 120 creates a test case that is specified by a test agent strategy 121. The test agent strategy varies scenario and/or vehicle parameters in such a way that the different vehicle derivatives or vehicle configurations can be tested in relevant, specific scenarios. For the validation of the ADAS/ADS, approaching the end of a traffic jam is an example of a test case. The test agent 120 takes the required information for this purpose from a calibration parameter database 131, a scenario database 132, and an evaluation database 133. For example, so-called criticality metrics are stored in the evaluation database 133, with which a performance of the ADAS/ADS can be quantified in the respective test cases, for example duration until standstill upon full braking or minimum duration until impact. A created test case is stored in a dynamic test database 110, on which the results achieved or the visualization 111 thereof also are deposited after simulation of the respective test case. The test case 102 then is transferred to a simulation unit 140. The simulation unit 140 contains multiple models, such as an environment model 141, a driver model 142, and a vehicle model 143. As a result, specific properties, such as the respective vehicle model 143, are provided for the simulation in which the ADAS/ADS then acts, and the properties are available to a simulation function 149 (“system under test,” abbreviated SUT) via X-in-the-loop simulation algorithms 145. The simulation results 104 are evaluated by an evaluation unit 150 in terms of performance 151 and simulation quality and are transmitted as an evaluation result 105 to the test agent 120. The results visualization 111 can then be used to compare on which vehicle the ADAS/ADS was the worst performing vehicle following the criticality metrics stored in the evaluation database 133. This vehicle thus identified as the worst-case vehicle and is selected for use in real tests. This vehicle then is used for a real test drive to validate the ADAS/ADS.

### LIST OF REFERENCE NUMBERS

100 Block diagram system
102 Test case
104 Simulation results
105 Evaluation results
110 Dynamic test database
111 Visualization of results
120 Test agent
121 Test agent strategy
131 Calibration parameter database
132 Scenario database
133 Evaluation database
140 Simulation unit
141 Environment model
142 Driver model
143 Vehicle model
145 X-in-the-loop integration
149 Simulation function
150 Evaluation unit
151 Evaluation of performance
152 Evaluation of simulation quality

1. A method for calibrating an advanced driver assistance system (ADAS) and/or an automated driving system (ADS) for a vehicle pool that comprises multiple vehicles, with each vehicle of the vehicle pool having a pre-set ADAS and/or ADS, the method comprising:
inputting vehicle parameters for all of the vehicles of the vehicle pool, the vehicle parameters that are inputted including engine specifications and brake specifications;
inputting test scenarios for which the pre-set ADAS/ADS of all vehicles in the vehicle pool are to be tested in a virtual driving environment;
inputting evaluation criteria with which a performance of the pre-set ADAS/ADS of all vehicles in the vehicle pool are to be evaluated;
virtual test driving all of the vehicles of the vehicle pool in the virtual driving environment, and recording results of the evaluation criteria for each virtual test drive;
using the evaluation criteria for evaluating all results for the virtual test drives and identifying the vehicle having the worst result as the worst-case vehicle;
selecting the real vehicle from the vehicle pool corresponding to the worst-case vehicle;
validating the ADAS/ADS by performing at least one real test drive with the worst-case vehicle for assessing the pre-set ADAS/ADS; and
calibrating the ADAS/ADS for all of the vehicles in the vehicle pool based on the assessing of the ADAS/ADS for the worst-case vehicle.

2. The method of claim 1, further comprising checking transferability of the calibrated ADAS/ADS on the worst-case vehicle to all other vehicles of the vehicle pool by performing additional virtual test drives.

3. The method of claim 1, wherein the respective vehicle parameters describing a particular vehicle model are associated with different vehicle derivatives and equipment variants.

4. The method of claim 1, wherein the test scenarios for testing the ADAS/ADS in the virtual environment include emergency braking at an end of a traffic jam as a function of different initial speeds.

5. The method of claim 1, wherein the evaluation criteria include at least one evaluation criterion selected from duration until standstill upon full braking and minimum duration until impact.

6. A system for calibrating an advanced driver assistance system (ADAS) and/or an automated driving system (ADS) for a vehicle pool that comprises multiple vehicles, with each vehicle of the vehicle pool having a pre-set ADAS and/or ADS, the system comprises a computing unit and a computer program product, the computer program product being configured to execute the ADAS/ADS with a virtual vehicle in a virtual environment, the ADAS/ADS also being executable in a real environment; the vehicle pool comprises multiple real vehicles, and each real vehicle of the vehicle pool can be mapped onto the virtual environment by vehicle parameters, and the system being configured to carry out the following:
inputting a vehicle model that is described by the vehicle parameters;
inputting test scenarios for which the ADAS/ADS is tested in the virtual environment with the respective vehicle;
inputting evaluation criteria with which a performance of the ADAS/ADS is evaluated in a test drive;
virtual test driving all vehicles of the vehicle pool, and recording results of the evaluation criteria for each of the test drives;
evaluating all results and identifying the vehicle having the worst result as the worst-case vehicle;
selecting the real vehicle from the vehicle pool corresponding to the worst-case vehicle; and
validating the ADAS/ADS by performing at least one real test drive with this vehicle.

7. The system of claim 6, wherein the system further is configured to check a transferability of the evaluation results for the performance of the ADAS/ADS on the worst-case vehicle to all other vehicles of the vehicle pool by additional virtual test drives.

8. The system of claim 7, wherein the vehicle parameters describing a particular vehicle model are associated with different vehicle derivatives and equipment variants.

9. The system of claim 8, wherein at least one scenario for testing the ADAS/ADS in the virtual environment is emergency braking at the end of a traffic jam as a function of different initial speeds.

10. The system of claim 9, wherein at least one evaluation criterion is selected from duration until standstill upon full braking and minimum duration until impact.

11. A computer program product having a computer-readable medium, on which is stored a program code that can be executed for calibrating an advanced driver assistance system (ADAS) and/or an automated driving system (ADS) for a vehicle pool comprising multiple real vehicles, with each of the vehicles of the vehicle pool having a pre-set ADAS and/or ADS, and wherein the program code, when executed on a computing unit, prompts the computing unit to carry out the following steps:
inputting vehicle parameters for all of the vehicles of the vehicle pool, the vehicle parameters that are inputted including engine specifications and brake specifications;
inputting test scenarios for which the pre-set ADAS/ADS of all vehicles in the vehicle pool are to be tested in a virtual driving environment;
inputting evaluation criteria with which a performance of the pre-set ADAS/ADS of all vehicles in the vehicle pool are to be evaluated;
virtual test driving all of the vehicles of the vehicle pool in the virtual driving environment, and recording results of the evaluation criteria for each virtual test drive;
using the evaluation criteria for evaluating all results for the virtual test drives and identifying the vehicle having the worst result as the worst-case vehicle;
selecting the real vehicle from the vehicle pool corresponding to the worst-case vehicle;
validating the ADAS/ADS by performing at least one real test drive with the worst-case vehicle for assessing the pre-set ADAS/ADS; and
calibrating the ADAS/ADS for all of the vehicles in the vehicle pool based on the assessing of the ADAS/ADS for the worst-case vehicle.
